(19) United States
(12) Patent Application Publication
(10) Pub. No.: US 2025/0049115 A1
(43) Pub. Date: Feb. 13, 2025

(54) LIGHT-GUIDING SEAL AND AEROSOL GENERATING DEVICE

(71) Applicant: SHENZHEN WOODY VAPES TECHNOLOGY CO., LTD., Shenzhen (CN)

(72) Inventors: Youming LIU, Shenzhen (CN); Yanming NIU, Shenzhen (CN); Yunyun DUAN, Shenzhen (CN)

(73) Assignee: SHENZHEN WOODY VAPES TECHNOLOGY CO., LTD., Shenzhen (CN)

(21) Appl. No.: 18/800,102

(22) Filed: Aug. 11, 2024

(30) Foreign Application Priority Data
Aug. 11, 2023 (CN) 202322164109.6

(51) Int. Cl. A24F 40/40; A24F 40/10; F21V 8/00

(52) U.S. Cl. CPC A24F 40/40; G02B 6/0073; G02B 6/0088; G02B 6/0095; A24F 40/10

(57) ABSTRACT

Disclosed are a light-guiding seal and an aerosol generating device. The light-guiding seal includes a fixing portion and a mounting portion. The fixing portion includes a mounting surface, a fixing surface opposite to the mounting surface, and a light guide hole, the light guide hole passes through the mounting surface and the fixing surface, and the fixing surface is fixedly connected to a lower housing. The mounting portion is disposed on the mounting surface and includes a mounting groove for mounting a light emitting member, an opening of the mounting groove is disposed on a top surface of the mounting portion, and a bottom of the mounting groove is in communication with the light guide hole.

### CROSS-REFERENCE TO RELATED APPLICATIONS

This application claims priority to Chinese Patent Application No. 202322164109.6, filed on Aug. 11, 2023, the entire disclosures of which are incorporated herein by reference.

### TECHNICAL FIELD

The present disclosure relates to atomization, and more particularly, to a light-guiding seal and an aerosol generating device.

### BACKGROUND

Aerosol generating devices enable an oil solution to be atomized into an aerosol through an atomizing core and deliver the aerosol to a user for inhale. When the aerosol flows inside the aerosol generating device from the atomizing core to the suction nozzle, it needs to pass through various components of the aerosol generating device, such as a nixie tube and an LED lamp. At present, the nixie tube of the aerosol generating device in the related art is generally exposed, and thus may be in contact with the aerosol, resulting in the presence of condensate or mist on the nixie tube, which not only affects display performance, but also may cause damage.

### SUMMARY

The present disclosure provides a light-guiding seal and an aerosol generating device, which can solve the problem that the aerosol adversely affects the display performance of the nixie tube and further causes damage to the nixie tube.

According to a first aspect, the present disclosure provides a light-guiding seal including a fixing portion and a mounting portion. The fixing portion includes a mounting surface, a fixing surface opposite to the mounting surface, and a light guide hole, the light guide hole passes through the mounting surface and the fixing surface, and the fixing surface is fixedly connected to a lower housing. The mounting portion is disposed on the mounting surface and includes a mounting groove for mounting a light emitting member, an opening of the mounting groove is disposed on a top surface of the mounting portion, and a bottom of the mounting groove is in communication with the light guide hole.

According to a second aspect, the present disclosure provides an aerosol generating device including a lower housing, a light-transmitting plate, a light-emitting member, and a light-guiding seal according to the first aspect above. The lower housing includes an opening at which the light-transmitting plate is disposed. A side of the light-emitting member is disposed on a circuit board, and another side of the light-emitting member is covered by the mounting portion of the light-guiding seal so that the light-emitting member is accommodated in the mounting groove. The light guide hole faces the light-transmitting plate.

### BRIEF DESCRIPTION OF THE DRAWINGS

In order to illustrate clearly the embodiments of the present disclosure, reference will be made briefly to the accompanying drawings. It will be apparent that the accompanying drawings in the following description illustrate some embodiments of the present disclosure, and that other drawings may be made to those skilled in the art based on these drawings without involving any inventive effort.

FIG. 1 is a front view of a light-guiding seal according to some embodiments of the present disclosure.

FIG. 2 is a back view of a light-guiding seal according to some embodiments of the present disclosure.

FIG. 3 is a schematic diagram of a light-emitting member of an aerosol generating device according to some embodiments of the present disclosure.

FIG. 4 is a side sectional view of an aerosol generating device according to some embodiments of the present disclosure.

FIG. 5 is a schematic diagram of a light-transmitting plate of an aerosol generating device according to some embodiments of the present disclosure.

FIG. 6 is a front sectional view of an aerosol generating device according to some embodiments of the present disclosure.

### LIST OF REFERENCE SIGNS

1000. Aerosol generating device; 100. Light-guiding seal; 10. Fixing portion; 11. Mounting surface; 12. Fixing surface; 13. Light guide hole; 14. Sealing rib; 20. Mounting portion; 21. Mounting groove; 22. Protective groove; 23. Top surface; 24. First side wall; 25. Second side wall; 27. Light-transmitting groove; 28. Accommodating groove; 30. Sealing portion; 200. Light-emitting member; 300. Circuit board; 400. LED lamp; 500. Light-transmitting plate; 510. Hollow area; 600. Lower housing; 610. Battery cell; 620. Wiring board; 630. Heat generating wire; 640. Gas passage; 650. Oil storage member; 660. Oil storage tube; 700. Upper housing.

### DETAILED DESCRIPTION OF EMBODIMENTS

Embodiments of the present disclosure will be described below with reference to the accompanying drawings. It is apparent that the described embodiments are only a part, rather than all of the embodiments of the present disclosure, and other embodiments made by a person of ordinary skill in the art, based on the embodiments of the present disclosure, without involving any inventive effort, fall within the scope of the present disclosure.

It will be understood that, the terms “include”, “including”, “comprise” and “comprising” as used in this specification and the appended claims specify the presence of the stated features, integers, operations, elements, and/or components, but do not preclude the presence or addition of one or more other features, integers, operations, elements, components, and/or any combination thereof.

It will also be understood that the terminology used in this specification of the various described embodiments herein is for the purpose of describing particular embodiments only and is not intended to be limiting. As used in the specification of the present disclosure and the appended claims, the singular forms “a”, “an”, and “the” are intended to include the plural forms as well, unless the context clearly indicates otherwise. It is further understood that the term “and/or” as used in the specification of the present disclosure and the appended claims refers to and encompasses any and all possible combinations of one or more of the associated listed items.

Further, the terms indicating direction and orientation, such as “up”, “down”, “front”, “back”, “left”, “right”, “inside”, “outside”, “side”, are only references to the direction illustrated in the drawings or showed in the product's state of use. Therefore, the use of the directional terms is intended to illustrate and understand the present disclosure, but not to be limiting. In addition, similar or identical structures in the accompanying drawings are indicated by the same reference numeral.

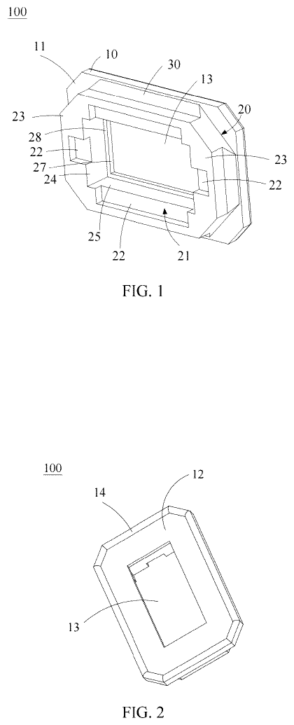

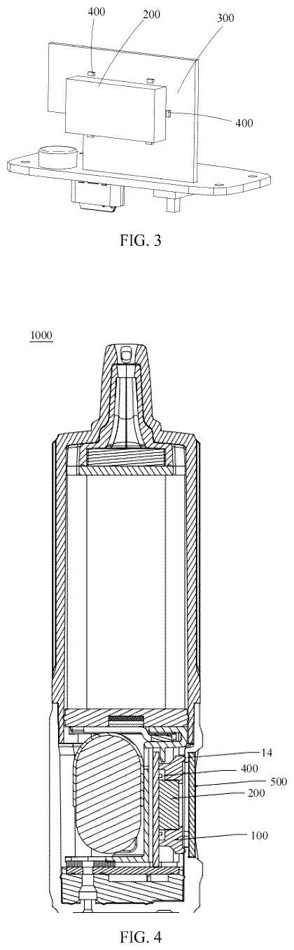

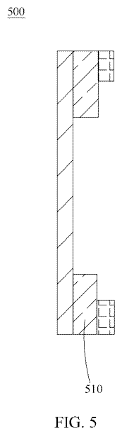

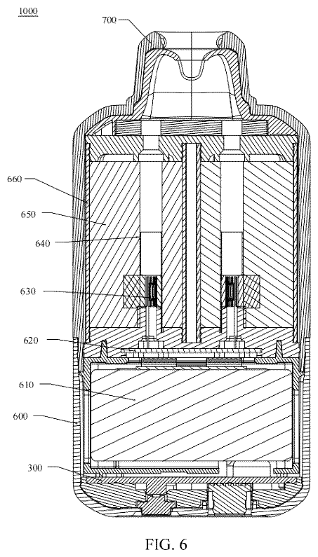

Referring to FIGS. 1 to 6, FIG. 1 is a front view of a light-guiding seal 100 according to some embodiments of the present disclosure; FIG. 2 is a back view of the light-guiding seal 100 according to some embodiments of the present disclosure; FIG. 3 is a schematic diagram of a light-emitting member 200 of an aerosol generating device 1000 according to some embodiments of the present disclosure; FIG. 4 is a side sectional view of the aerosol generating device 1000 according to some embodiments of the present disclosure; FIG. 5 is a schematic diagram of a light-transmitting plate 500 of the aerosol generating device 1000 according to some embodiments of the present disclosure; FIG. 6 is a front sectional view of the aerosol generating device 1000 according to some embodiments of the present disclosure. As shown in FIGS. 1 to 2, the light-guiding seal 100 includes a fixing portion 10 and a mounting portion 20. The fixing portion 10 has a mounting surface 11 and a fixing surface 12. A light guide hole 13 is disposed on the fixing portion 10 and passes through the mounting surface 11 and the fixing surface 12. The fixing surface 12 is fixedly connected to a lower housing 600. The mounting portion 20 is provided on the mounting surface 11, and a mounting groove 21 is disclosed on the mounting portion 20. An opening of the mounting groove 21 is located at the top surface 23 of the mounting portion 20, and a bottom is in communication with the light guide hole 13. The mounting groove 21 is configured to mount the light-emitting member 200.

The fixing portion 10 and the mounting portion 20 may be integrally molded or provided separately. The mounting surface 11 and the fixing surface 12 of the fixing portion 10 are opposite to each other, and the fixing surface 12 is configured to connect with the lower housing 600 of the aerosol generating device 1000. The mounting groove 21 may be formed by recessing the top surface 23 of the mounting portion 20 disposed on the mounting surface 11, so that the opening of the mounting groove 21 is disposed on the top surface 23 of the mounting portion 20, and the bottom is in communication with the light guide hole 13. For example, the bottom of the mounting groove 21 may be hollowed out so that the light guide hole 13 communicates with the mounting groove 21. When mounted, referring to FIGS. 1 to 6, the light-emitting member 200 is fixed to a circuit board 300 and covered by the mounting groove 21 of the mounting portion 20. The top surface 23 of the mounting portion 20 is fixedly connected to the circuit board 300 to seal the light-emitting member 200. The fixing surface 12 of the fixing portion 10 is fixedly connected to the lower housing 600, and the lower housing 600 includes an opening that directly faces the light guide hole 13. The light-transmitting plate 500 is provided on the light guide hole 13, so that the light-emitting member 200 can be observed from the outside. The light-emitting member 200 may be a nixie tube or a display screen for displaying related information of the aerosol generating device 1000.

In some embodiments, one or more protective grooves 22 are disposed on the top surface 23 of the mounting portion 20, wherein the opening of each of the protective grooves 22 is at the top surface 23.

Referring to FIGS. 1 and 3, the one or more protective grooves 22 on the top surface 23 of the mounting portion 20 are configured to accommodate LED lamps 400, so as to prevent the LED lamps 400 from being in direct contact with the aerosol. The number of protective grooves 22 is related to the number of LED lamps 400, which may be one-to-one or one-to-many.

In some embodiments, the mounting groove 21 comprises two opposite first side walls 24 and two opposite second side walls 25. At least one of the protective grooves 22 is disposed on the top surface 23 of the mounting portion 20 close to the first side walls 24, and at least one of the protective grooves 22 is disposed on the top surface 23 close to the second side walls 25.

The mounting groove 21 includes four side walls, two first side walls 24 and two second side walls 25, and at least one of the protective grooves 22 may be disposed close to the first side walls 24 and the second side walls 25 to protect the LED lamps 400 located around the light-emitting element 200.

In some embodiments, two of the protective grooves 22 are disposed on the top surface 23 of the mounting portion 20 close to the second side walls 25 and communicate with each other.

Referring to FIG. 1, two of the protective grooves 22 may be disposed close to the second side walls 25 and communicate with each other to form an elongated shape, which facilitates protection of a plurality of LED lamps 400 at the same time.

In some embodiments, the protective grooves 22 communicate with the mounting groove 21.

When the protective grooves 22 communicate with the mounting groove 21, one or more the protective grooves 22 close to the first side walls 24 are connected with the first side walls 24, and one or more protective grooves 22 close to the second side walls 25 are connected with the second side walls 25.

In some embodiments, the mounting groove 21 includes a light-transmitting groove 27 and an accommodating groove 28, which are in communication with each other. An opening of the light-transmitting groove 27 corresponds to a bottom of the accommodating groove 28, and a bottom of the light-transmitting groove 27 communicates with the light guide hole 13. An opening of the accommodating groove 28 is located on the top surface 23.

The light-transmitting groove 27 is disposed close to the mounting surface 11, the accommodating groove 28 is disposed close to the top surface 23 of the mounting portion 20, and the light-transmitting groove 27 communicates with the accommodating groove 28. The opening of the light-transmitting groove 27 corresponds to the bottom of the accommodating groove 28, the bottom of the light-transmitting groove 27 communicates with the light guide hole 13, and the opening of the accommodating groove 28 is located on the top surface 23, so as to better seal the light-emitting member 200.

In some embodiments, a sealing rib 14 is circumferentially disposed on the connection between the fixing surface 12 and the lower housing 600.

Referring to FIG. 2, the sealing rib 14 is circumferentially disposed on the connection between the fixing surface 12 and the lower housing 600 to improve the sealing performance and prevent the aerosol from coming into contact with the light-emitting member 200.

In some embodiments, a sealing portion 30 is disposed on the connection between the mounting portion 20 and the fixing portion 10. The sealing portion 30 is obliquely provided from the mounting portion 20 toward the fixing portion 10.

Referring to FIG. 1, arranging the sealing portion 30 in an oblique form may prevent the aerosol from entering the mounting groove 21 and improve the sealing performance.

Referring to FIGS. 4 to 6, the present disclosure further provides the aerosol generating device 1000, including the lower housing 600, the light-transmitting plate 500, the light-emitting member 200, and the light-guiding seal 100 according to any one of the above embodiments. The lower housing 600 includes an opening, at which the light-transmitting plate 500 is disposed. A side of the light-emitting member 200 is disposed on the circuit board 300, and the other side is covered by the mounting portion 20 of the light-guiding seal 100 so that the light-emitting member 200 is accommodated in the mounting groove 21. The fixing surface 12 of the light-guiding seal 100 is connected to the lower housing 600, and the light guide hole 13 faces the light-transmitting plate 500.

Referring to FIG. 5, the aerosol generating device 1000 according to some embodiments of the present disclosure includes the lower housing 600, the light-guiding seal 100, the light-emitting member 200, and the light-transmitting plate 500. The light-transmitting plate 500 is disposed on and is connected in seal to the opening of the lower housing 600, so that a seal space is formed in the lower housing 600. The light-emitting member 200 is fixed on the circuit board 300 and covered by the mounting groove 21 of the light-guiding seal 100 so that the light-emitting member 200 is accommodated in the light-guiding seal 100. The light guide hole 13 of light-guiding seal 100 faces the light-transmitting plate 500, so that the user can observe the display information of the light-emitting member 200 through the opening of the lower housing 600, and thus determine the working condition of the aerosol generating device 1000. The light-transmitting plate 500 and the lower housing 600 together with the circuit board 300 and the mounting groove 21 create a sealed structure to prevent the light-emitting member 200 from being in contact with the aerosol. In addition, the aerosol generating device 1000 according to the present disclosure may further include a battery cell 610, a wiring board 620, a heat generating wire 630, a gas passage 640, an oil storage member 650, an oil storage tube 660, and an upper housing 700. The upper housing 700 is connected to the lower housing 600 to form a sealed space therebetween. The battery cell 610 is disposed in the lower housing 600 and configured to supply power to the aerosol generating device 1000. The oil storage member 650 is used to store an oil solution to be atomized, which can enter an atomizing module through the oil storage tube 660 and be atomized into the aerosol through the heat generating wire 630 in the atomizing module. The heat generating wire 630 is disposed on the wiring board 620. The aerosol generating device 1000 according to the present disclosure may also include other structures commonly used in the art, and will not be described in detail herein.

In some embodiments, the light-transmitting plate 500 includes an ink layer, and a hollow area 510 in which characters are provided is disposed on the ink layer.

Referring to FIG. 5, the hollow area 510 is disposed on the ink layer of the light-transmitting plate 500. When the LED lamps 400 emit light, the light may be diffused in the hollow area 510, and in case characters are provided in the hollow area 510, the characters are shown at the light-transmitting plate 500.

According to the light-guiding seal and the aerosol generating device of the embodiments of the present disclosure, the light-guiding seal includes the fixing portion and the mounting portion, the fixing surface of the fixing portion is fixedly connected to the lower housing, and the mounting surface is connected with the mounting portion. The bottom of the mounting groove of the mounting portion is in communication with the light guide hole, and the light-emitting member can be accommodated in the mounting groove. Further, the mounting portion is fixed to the circuit board, thereby completing the sealing of the light-emitting member. As a result, in case of without affecting the light-emitting member, the mounting groove may protect the light-emitting member from being contacted with the aerosol and avoid decrease of display performance of the light-emitting member and damage to the light-emitting member by the aerosol.

The above description only relates to some specific implementations of the present disclosure, but is not intended to limit the scope of the present disclosure. Any skilled person familiar with the technical field can easily conceive of various equivalent modifications or substitutions based on the embodiments of the present disclosure, and such modifications or substitutions shall be encompassed within the scope of the present disclosure. The scope of the present disclosure shall be defined by with the appended claims.

What is claimed is:

1. A light-guiding seal comprising:
a fixing portion comprising a mounting surface and a fixing surface opposite to each other, wherein a light guide hole is provided to pass through the mounting surface and the fixing surface, and the fixing surface is fixable on a lower housing; and
a mounting portion disposed on the mounting surface and configured to provide a mounting groove for mounting a light-emitting member, wherein an opening of the mounting groove is disposed on a top surface of the mounting portion, and a bottom of the mounting groove is in communication with the light guide hole.

2. The light-guiding seal according to claim 1, wherein one or more protective grooves are disposed on the top surface of the mounting portion, and an opening of each of the protective grooves is disposed on the top surface.

3. The light-guiding seal according to claim 2, wherein the mounting groove comprises two opposite first side walls and two opposite second side walls, at least one of the protective grooves is disposed on the top surface of the mounting portion close to the first side walls, and at least one of the protective grooves is disposed on the top surface of the mounting portion close to the second side walls.

4. The light-guiding seal according to claim 3, wherein two of the protective grooves are disposed on the top surface of the mounting portion close to the second side walls, and are in communication with each other.

5. The light-guiding seal according to claim 4, wherein the protective grooves are in communication with the mounting groove.

6. The light-guiding seal according to claim 1, wherein the mounting groove comprises a light-transmitting groove and an accommodating groove, wherein the light-transmitting groove and the accommodating groove are in communication with each other, an opening of the light-transmitting groove is used as a bottom of the accommodating groove, a bottom of the light-transmitting groove is in communication with the light guide hole, and an opening of the accommodating groove is disposed on the top surface.

7. The light-guiding seal according to claim 1, wherein a sealing rib is disposed on a connection between the fixing surface and the lower housing.

8. The light-guiding seal according to claim 1, wherein a sealing portion is disposed on a connection between the mounting portion and the fixing portion, and the sealing portion is obliquely disposed from the mounting portion toward the fixing portion.

9. The light-guiding seal according to claim 1, wherein the fixing portion and the mounting portion are integrally formed or provided separately.

10. An aerosol generating device comprising a lower housing, a light-transmitting plate, a light-emitting member, and a light-guiding seal,
wherein the light-guiding seal comprises:
a fixing portion comprising a mounting surface and a fixing surface opposite to each other, wherein a light guide hole is provided to pass through the mounting surface and the fixing surface, and the fixing surface is fixable on the lower housing; and
a mounting portion disposed on the mounting surface and configured to provide a mounting groove for mounting a light emitting member, wherein an opening of the mounting groove is disposed on a top surface of the mounting portion, and a bottom of the mounting groove is in communication with the light guide hole,
wherein the lower housing comprises an opening at which the light-transmitting plate is disposed,
a side of the light-emitting member is disposed on a circuit board, and another side of the light-emitting member is covered by the mounting portion of the light-guiding seal so that the light-emitting member is accommodated in the mounting groove, and
the light guide hole faces the light-transmitting plate.

11. The aerosol generating device according to claim 10, wherein the light-transmitting plate comprises an ink layer, a hollow area is disposed on the ink layer, and characters are provided in the hollow area.

12. The aerosol generating device according to claim 10, wherein one or more protective grooves are disposed on the top surface of the mounting portion, and an opening of each of the protective grooves is disposed on the top surface.

13. The aerosol generating device according to claim 12, wherein the mounting groove comprises two opposite first side walls and two opposite second side walls, at least one of the protective grooves is disposed on the top surface of the mounting portion close to the first side walls, and at least one of the protective grooves is disposed on the top surface of the mounting portion close to the second side walls.

14. The aerosol generating device according to claim 13, wherein two of the protective grooves are disposed on the top surface of the mounting portion close to the second side walls, and are in communication with each other.

15. The aerosol generating device according to claim 14, wherein the protective grooves are in communication with the mounting groove.

16. The aerosol generating device according to claim 10, wherein the mounting groove comprises a light-transmitting groove and an accommodating groove which are in communication with each other, an opening of the light-transmitting groove corresponds to a bottom of the accommodating groove, a bottom of the light-transmitting groove is in communication with the light guide hole, and an opening of the accommodating groove is disposed on the top surface.

17. The aerosol generating device according to claim 10, wherein a sealing rib is disposed on a connection between the fixing surface and the lower housing.

18. The aerosol generating device according to claim 10, wherein a sealing portion is disposed on a connection between the mounting portion and the fixing portion, and the sealing portion is obliquely disposed from the mounting portion toward the fixing portion.

19. The aerosol generating device according to claim 10, wherein the fixing portion and the mounting portion are integrally formed or provided separately.

20. The aerosol generating device according to claim 12, further comprising an upper housing connected to the lower housing to seal the lower housing, and
LED lamps disposed around the light-emitting member, wherein the protective grooves are configured to accommodate and protect the LED lamps.
